(19) United States
(12) Patent Application Publication
(10) Pub. No.: US 2010/0020002 A1
(43) Pub. Date: Jan. 28, 2010

(54) SCANNING BACKLIGHT FOR LCD

(75) Inventors: Roel Van Woudenberg, Eindhoven (NL); Hendrikus Willem Groot Hulze, Eindhoven (NL); Jeroen Hubert Christoffel Jacob Stessen, Eindhoven (NL); Aleksandar Sevo, Eindhoven (NL); Gerben Johan Hekstra, Eindhoven (NL); Hendrik Jan Blankers, Oss (NL); Vedran Kovacevic, Eindhoven (NL); Jeroen Den Breejen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,194

(22) PCT Filed: Dec. 22, 2005
(86) PCT No.: PCT/IB05/54377

§ 371 Date: Jun. 20, 2007

(30) Foreign Application Priority Data
Dec. 27, 2004 (EP) 04106987.3

(51) Int. Cl. G09G 3/36

(52) U.S. Cl. 345/102

(57) ABSTRACT

A method for displaying images on a display having backlight is disclosed, where the images is updated periodically with a period. The method comprises the steps of: generating a signal with a pulse pattern for each period depending on the contents of an image to be displayed in that period; and activating backlight in accordance with the signal. Further, a display (100) comprising a display panel (102) and a backlight unit, wherein the backlight unit comprises a controller (104) and a lighting device is disclosed. The controller (104) is arranged to generate a control signal, and the lighting device is arranged to provide backlight to the display panel (102) according to the control signal, wherein the control signal comprises a pulse pattern depending on contents of displayed images.

### TECHNICAL FIELD

The present invention relates to a method and a display, wherein backlight is generated depending on contents of displayed images.

### BACKGROUND OF THE INVENTION

LCD (Liquid Crystal Display) panels suffer from motion blur due to their sample-and-hold nature, i.e. the LC (Liquid Crystal) remains in the same state after addressing during a whole frame. When displayed objects move, as is the case in e.g. TV images, this causes a blurred image of the objects on the retina of a viewer. In US 2004/0012551 A, it is disclosed a means to drive the data for the value corresponding to a present frame display data. By comparing with previous frame of display data, the display data in the present frame that have changes are then over emphasized and written into the LCD driver with more than the amount of change to the picture element data. Further, a backlight control means to control the lighting delay time, the lighting time width, the lighting time interval and the number of times of lighting within one frame of a LCD backlighting is disclosed. However, there is a need for improved backlight control to avoid a flickering image.

### SUMMARY OF THE INVENTION

It is therefore an object of the present invention to provide an improved method for displaying images on a display, and an improved display.

The above object is achieved according to a first aspect of the present invention by a method for displaying images on a display having backlight, wherein the images are updated periodically with a period. The method comprises the steps of: generating a signal with a pulse pattern for each period depending on contents of an image to be displayed in that period; and activating the backlight in accordance with said signal.

An advantage of this is that the backlighting is depending on the contents of the displayed images for providing an image that is experienced as less flickering.

The backlight may comprise a plurality of lighting units and each lighting unit is associated with a part of the display, wherein the steps of generating a signal and activating backlight are separately adapted to each of the parts.

An advantage of this is that an image comprising contents with very different contents in different parts is improved in each part.

The pulse pattern may comprise a plurality of pulses for each period when contents of the displayed image comprise relatively high brightness.

An advantage of this is that a viewer often experiences a bright image as more flickering, but this is compensated for by increasing the backlighting frequency for such images.

The term “relatively high brightness” should in this context be construed to be a brightness essentially higher than an average brightness of an average image.

The plurality of pulses may be symmetrical during said period when contents of displayed images comprise low changes between subsequent images.

An advantage of this is optimal reduced flickering when an image is relatively static, i.e. when a viewer would experience flickering the most, and the equal distribution would not introduce any blurring.

The plurality of pulses may be asymmetrical during said period when contents of displayed images comprise high changes between subsequent images.

An advantage of this is reduced flickering, and counteracting blurring by distributing the pulses asymmetrically when there is a lot of motion in the image.

The pulse pattern may comprise one pulse for each period when contents of displayed images comprise high changes between subsequent images and relatively low brightness.

The term “relatively low brightness” should in this context be construed to be a brightness essentially lower than an average brightness of an average image.

An advantage of this is optimized counteracting of blurring, while there is little or no experienced flickering due to low brightness.

By symmetrical pulses, it is meant that the pulse in each half of the frame period is symmetrical in effective brightness and position, and for higher multiples of frequency, for each corresponding fraction of frame period. By asymmetrical pulses, it is meant that the pulse in each half of the frame period is symmetric in effective brightness and/or position, and for higher multiples of frequency, for each corresponding fraction of frame period. Effective brightness depend on pulse amplitude and/or width.

Where contents change, the method may further comprise the steps of: generating said signal with a first pattern; generating said signal with intermediate patterns; and generating said signal with a second pattern, wherein said intermediate patterns are such that an average value of said signal is kept constant upon a transition from said first pattern to said second pattern.

An advantage of this is a seamless transition from one backlighting pattern to another, without any brightness dips or peaks. This is particularly advantageous when transition from one backlighting pattern to another is performed within a single image, i.e. from one part to another.

Where the first pattern is a single pulse for each period, and the second pattern is two symmetrical pulses, the intermediate patterns may be two pulses with different effective pulse brightnesses. Where the first pattern is two symmetrical pulses, and the second pattern is a single pulse for each period, the intermediate patterns may be two pulses with different effective pulse brightnesses. An aggregated effective pulse brightness of said pulses within each period may be constant.

An advantage of this is an efficient way to seamlessly transition from one backlighting scheme to another.

The above object is achieved according to a second aspect of the present invention by a display comprising a display panel and a backlight unit, wherein the backlight unit comprises a controller and a lighting device, wherein the controller is arranged to generate a control signal, and the lighting device is arranged to provide backlight to the display panel according to the control signal, wherein the control signal comprises a pulse pattern depending on contents of displayed images.

The backlight unit may comprise a plurality of lighting devices, and each lighting device is associated with a part of the display, and the control signal is separately adapted to each of the parts.

The advantages of the second aspect of the present invention are essentially the same as those of the first aspect.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 illustrates a display according to an embodiment of the present invention;

FIG. 2 is a mode transition diagram showing transition between two modes via intermediate modes;

FIG. 3 is a mode transition diagram showing transition between modes related to image contents;

FIG. 4 is a flow chart illustrating a method according to an embodiment of the invention;

FIG. 5 is a flow chart illustrating a method for mode transition;

FIGS. 6-20 are pulse diagrams; and

FIG. 21 illustrates a display according to another embodiment of the present invention.

### DETAILED DESCRIPTION OF THE PREFERRED EMBODIMENTS

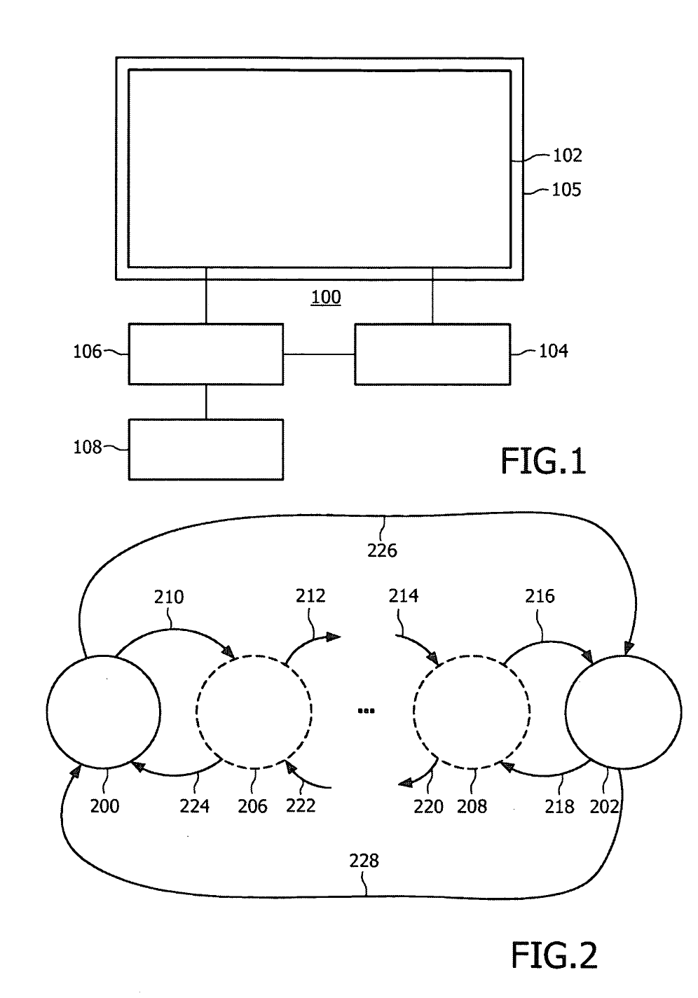

FIG. 1 illustrates a display 100 comprising a display panel 102. The display panel 102, which can be a LCD (Liquid Crystal Display) panel, is provided with backlighting 105. The backlighting 105 can for example comprise one or more light sources (not shown), such as light emitting diodes (LEDs) or gas discharge lamps. The backlight is flashed, either for the entire panel 102 or, preferably, by scanning backlight segments of the panel 102. Thus, an LC cell is illuminated only for a certain fraction of the frame time. A backlight controller 104, which is connected to the backlighting 105 of the panel 102, controls backlight flashing. To avoid large area flicker, the backlight controller 104 provides a backlight control signal which is dependent on an image displayed on the panel 102. Therefore, the backlight controller 104 is connected to a display controller 106, which in turn receives image data from an image data source 108. It should be noted that this description is for illustrative purpose, and both the backlight controller 104 and the display controller 106 can be a common video controller, or divided between two or more units, which provide the same function as the backlight and display controllers 104, 106. The data source 108 can be a TV decoder, a DVD player, a computer, or any other means providing images to be viewed on the display 100.

An effective way to reduce large area flicker and achieving motion blur reduction would be to drive the panel at a higher refresh rate and use motion-compensated video up-conversion to achieve a higher video rate with smooth motion. For an LCD it is however not possible to increase refresh rate above 75-80 Hz. Moreover, it is very expensive to up-convert video signals with motion compensation. The present invention provides a less expensive way to achieve less flicker and less motion blurring.

To achieve this, the backlight is operated at double refresh frequency, or a higher multiple. This introduces a higher frequency brightness modulation, which is far above the flicker threshold, even for a white image.

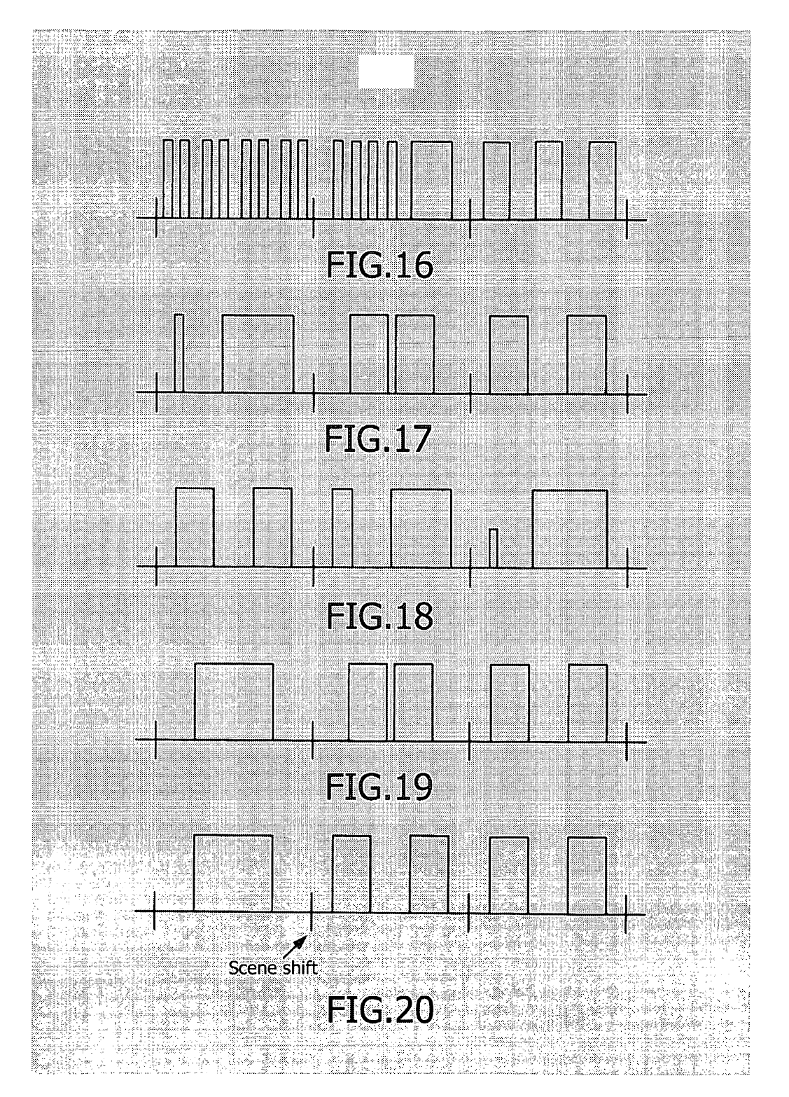

To provide a clearer view in examples provided below, FIGS. 6-20 illustrate a plurality of pulse patterns in pulse diagrams, which will be referred to in the description of the embodiments. It should be noted that the pulse diagrams show principles, from which the artisan is able to understand the spirit of the invention according to the embodiments presented below, and pulse shapes, widths, amplitudes and positions, as well as ways of transition from one pulse pattern to another via intermediate pulse patterns, are simplified to avoid obscuring the basic ideas of the present invention.

FIG. 6 is a pulse diagram illustrating a single pulse per frame period, i.e. one pulse is provided for each period of refresh of the display. The effective brightness produced by the pulse, by controlling a light generating means, or regarding the pulse as an output of the light generating means, is dependent on the pulse width and the amplitude of the pulse.

FIG. 7 is a pulse diagram illustrating a symmetrical double pulse, i.e. there is provided two pulses for each frame period and the pulses in each half of the frame period is symmetrical in effective brightness and position.

FIG. 8 is a pulse diagram illustrating an asymmetrical double pulse, which pulses are symmetric in position, but asymmetric in effective brightness, i.e. there are two pulses for each frame period that are symmetric in position, but the pulse in each half of the frame period is asymmetric in effective brightness. Thus, the double pulse, considered as a whole, is asymmetric.

FIG. 9 is a pulse diagram illustrating an asymmetrical single pulse, where the pulse is asymmetrical in sense of position.

FIG. 10 is a pulse diagram illustrating an asymmetrical double pulse where the pulse pattern is asymmetrical in sense of effective brightness, since the amplitudes of the pulsed differ.

FIG. 11 is a pulse diagram illustrating a double pulse pattern, where the two pulses are close together to achieve a lighting effect relatively similar to a single pulse pattern as illustrated in FIG. 6, and are therefore referred to as a quasi-single pulse.

FIG. 12 is a pulse diagram illustrating a double pulse pattern, where the two pulses provide very different effective brightness by having very different pulse widths. Also with this pattern, a lighting effect relatively similar to a single pulse pattern as illustrated in FIG. 9 is achieved, and is therefore also referred to as a quasi-single pulse. FIG. 13 illustrates an even more extreme quasi-single pulse pattern, where two pulses are very different in both pulse width and amplitude.

FIG. 14 is a pulse diagram illustrating a transition between two pulse patterns, where a brightness peak occurs at the transition. During a period, here marked by a bracket, the average pulse width and amplitude are higher than over other periods, and a brightness peak can be experienced by a viewer.

FIG. 15 is a pulse diagram illustrating a transition between two pulse patterns, where a brightness dip occurs at the transition. During a period, here marked by a bracket, the average pulse width and amplitude are lower than over other periods, and a brightness dip can be experienced by a viewer.

FIG. 16 is a pulse diagram illustrating a first pulse pattern with eight symmetrical pulses, and a transition to another pulse pattern with three symmetrical pulses via an intermediate pulse pattern, which is asymmetrical and comprises five pulses.

FIG. 17 is a pulse diagram illustrating a transition from a quasi-single pulse pattern, similar to that illustrated in FIG. 12, to a symmetrical pulse pattern, similar to that illustrated in FIG. 7, via an intermediate pulse pattern, here illustrated similar to the quasi-single pulse pattern as illustrated in FIG. 11. It should be noted that a transition via intermediate pulse patterns normally comprises more patterns to achieve a seamless transition, and FIG. 17 illustrates the principle to avoid a brightness peak, which would occur as illustrated in FIG. 14.

FIG. 18 illustrates the use of intermediate pulse patterns when a transition is to be made to a more extreme pulse pattern.

FIG. 19 illustrates transition from a single pulse pattern to a double pulse pattern via a quasi-single pulse pattern as intermediate pulse pattern.

FIG. 20 is a pulse diagram illustrating an instantaneous transition without intermediate pulse patterns when a scene shift is occurring. This is possible, since brightness dips or peaks would not be visible at a scene shift. Thus, no transition using intermediate pulse patterns is needed.

The operation will be described with an example using double pulses in a display refresh period, i.e. double frequency, but the same principle applies for three or more pulses in a period, i.e. higher multiples of frequency.

For a perfect flicker reduction, these two pulses need to be spaced exactly half a frame distance apart and to have the exactly the same brightness, i.e. symmetrical pulses as illustrated in FIG. 7, resulting in a pure double frequency backlight pulsing. It is observed for 50 Hz display refresh and double flashing, flicker is already visible when the two pulses differ 0.5% in brightness at a total display brightness of 500 cd/m² and for 60 Hz display refresh and double flashing, flicker is visible at 3.5% difference in brightness between the pulses.

The lamps are preferably operated at a fixed current. Therefore, the backlight brightness modulation is preferably done using pulse width modulation. The pulses can also comprise a series of even higher frequency pulses, i.e. the modulation can be done by pulse number modulation of pulse trains. Further, the amplitude of the pulses can be modulated, and a combination of the above mentioned backlight modulation techniques can be applied.

Flicker is most visible in bright scenes with little or no motion, although flicker also is visible in bright scenes with a lot of motion, but in the latter case, motion blur problems increase. For example, when a bright scene with some or a lot of motion is paused, flicker becomes more visible, but motion blur problems, of course, disappear. Therefore, the backlight is operated in double pulse mode, with the two pulses in the frame exactly spaced at half a frame distance, and with exactly the same brightness for the two pulses, when the flicker problem is the most apparent.

When there is some or a lot of motion in the scene, it is only needed to introduce a bit of higher frequency content in the brightness modulation. Therefore, backlight is operated with two pulses spaced at half a frame distance, but with different brightness of the pulses. A first pulse, half a frame period earlier than the second pulse takes care of reducing the flicker to a large extent, while it is sufficiently low in brightness not to cause a clear double image or to cause blur. The second pulse gives the main brightness.

Alternatively, two pulses of same brightness can be moved closer together, as illustrated in FIG. 11, to improve moving image quality compared to distributing the pulses at half frame period distance and at the same time having some higher frequencies in the display brightness to reduce flicker. The reduction of motion blur is now due to that the two illuminated images in this case of asymmetrically distributed pulses are closer in time.

By asymmetrically distributed pulses, it is meant that the pulse in each half of the frame period is asymmetric in effective brightness and position, and for higher multiples of frequency, for each corresponding fraction of frame period.

It is observed that for a total duty cycle of 40%, the flicker of a 25% to 75% pulse ratio is the same as of two pulses of 20% duty cycle each separated by approximately 2/7 of a frame period, center to center. It is also observed that moving image quality is very similar for these two cases for both natural scenes and edge quality.

When there is little or no motion and the scene is not too bright, it is preferable to use the asymmetrical pulse distribution. However, in this case it is not critical and the backlight mode can be chosen arbitrarily, preferably in a way to avoid mode change.

When there is a lot of motion and the scene is not too bright, no flicker reduction is needed, and a single or quasi-single pulse backlight operation can be used to achieve best performance for scenes with a lot of motion.

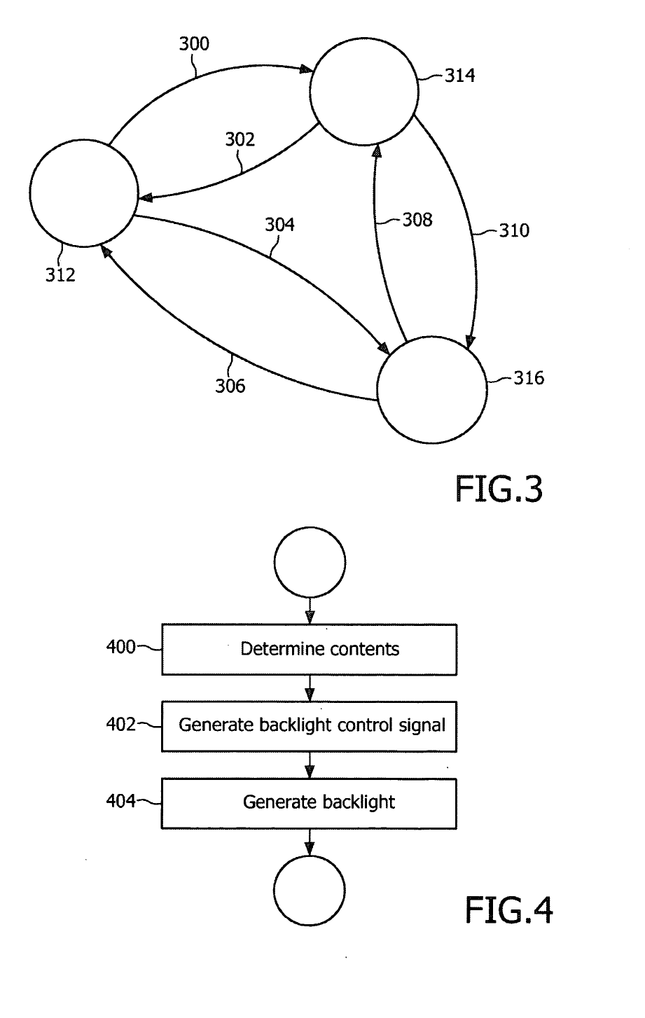

FIG. 2 is a mode transition diagram showing transition between two modes 200, 202 via intermediate modes 206, 208. If a direct transition to another mode is performed instantaneously, the effect could be that there is a larger gap between the last pulse of the first mode and the first pulse of the second mode, causing a brightness dip due to that the average value of the pulses temporarily dips, as illustrated in FIG. 15, or that there is a smaller gap between the last pulse of the first mode and the first pulse of the second mode, causing a brightness peak, as illustrated in FIG. 14. To avoid these backlight dips or peaks during change of backlight mode, intermediate modes 206, 208 are formed to achieve a seamless transition.

To illustrate this, the operation will be described for double pulse as in the example above in relation to FIG. 1, i.e. double frequency, but as above, the same principle applies for three or more pulses, i.e. higher multiples of frequency. For an illustrative example, transition is to be performed between a single pulse mode 200 to a symmetrical double pulse mode 202. This can for example be the case when a scene with low brightness and a lot of motion changes to high brightness and little or no motion.

A first transition 210 is performed to a first intermediate mode 206. This mode can be a double pulse mode with asymmetrical pulses, e.g. a pulse width ratio of 5% to 95%, and only a small distance between the pulses, i.e. a double pulse pattern that is relatively similar to the single pulse pattern. A second transition 212 is then performed to a second intermediate mode (not shown) with two pulses with less asymmetry, and then further transitions to intermediate modes with more and more symmetry to a transition 214 to a last intermediate mode 208 where the pulse width ratio between the pulses is almost 50% to 50% and the distance between the pulses is almost a half frame distance, center to center. A last transition 216 is performed is performed to the symmetrical double pulse mode 202, where the pulse width ratio is exactly 50% to 50%, and the distance between the pulses is exactly a half frame distance, center to center. The transition between the modes 200, 202 is then complete, and performed such that a viewer do not experience any dips or peaks in brightness. The transitions 210, 212, 214, 216 can be performed between each frame, or between each couple of frames.

Alternatively, the transition is performed, as illustrated in FIG. 19, by forming a quasi-single pulse pattern with two pulses with equal effective brightness, and then separating the pulses in one or more steps to get to the symmetrical pulse pattern.

The same applies with transition from symmetrical double pulse mode 202 to single pulse mode 200 via intermediate modes 208, 206 and transitions 218, 220, 222, 224.

This example illustrated transition between single pulse mode and symmetrical double pulse mode. The same principle applies between other modes, e.g. between single pulse mode and asymmetrical double pulse mode, and between symmetrical and asymmetrical double pulse modes. Further, the principle is also applicable to multi pulse modes. The general principle of the transitions is to insert intermediate modes that gradually change the pulse patterns from one mode to another to avoid brightness dips or peaks.

When there is a change of scene, a transition can be made directly from the first mode 200 to the second mode 202 by a direct transition 226, and from the second mode 202 to the first mode 200 by a direct transition 228. A control signal, from e.g. the display controller, would enable the backlight controller to do such direct transitions 226, 228.

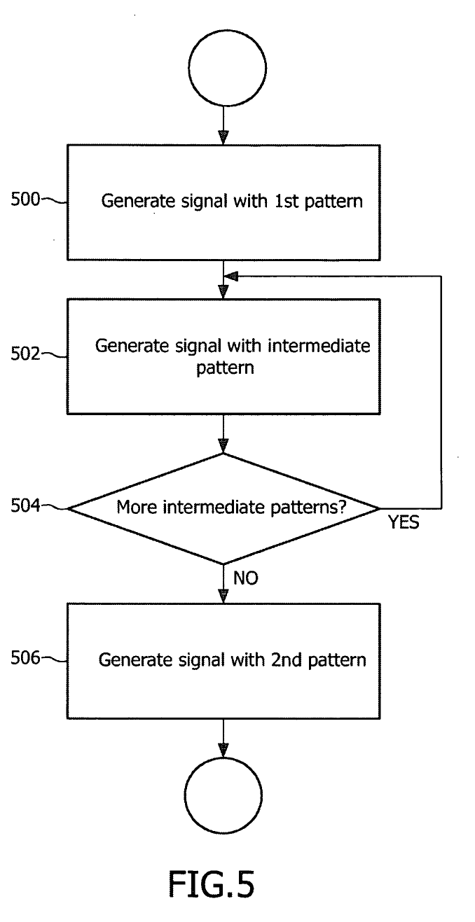

FIG. 3 is a mode transition diagram showing transitions 300, 302, 304, 306, 308, 310 between modes 312, 314, 316 related to image contents. Each of the transitions 300, 302, 304, 306, 308, 310 can comprise intermediate modes, as illustrated in FIG. 2. Three modes 312, 314, 316 are illustrated as an example, e.g. single pulse mode 312, asymmetrical double pulse mode 314, and symmetrical double pulse mode 316. However, more modes can be comprised, e.g. different quasi-single pulse modes, asymmetrical modes, and modes with three or more pulses.

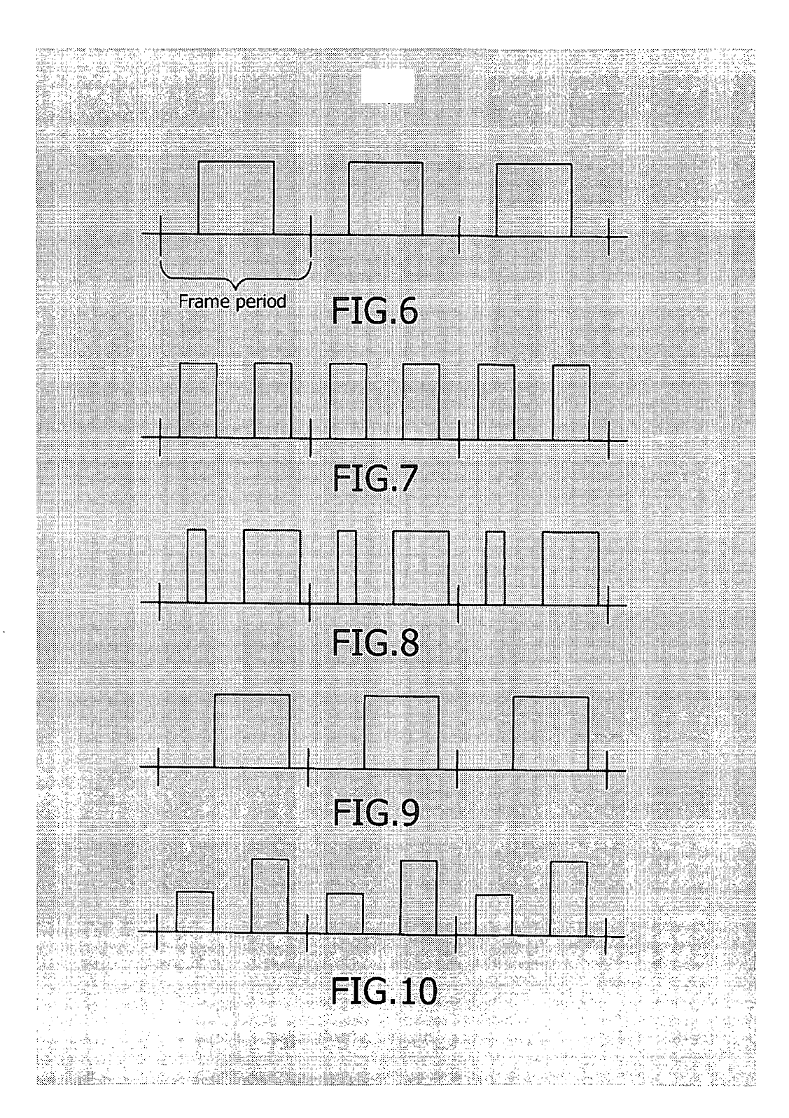

FIG. 4 is a flow chart illustrating a method according to an embodiment of the invention. In a content determination step 400, the contents of the image is determined. Contents can comprise brightness of the image or a part of the image, and presence of motion in the image. A backlight control signal is generated in a backlight generation step 402 in dependence on the determined contents. Examples of this dependence is described above. Backlight is then activated based upon the backlight control signal in a backlight generation step 404. The backlight is activated with a backlight driver driving lamps or LEDs.

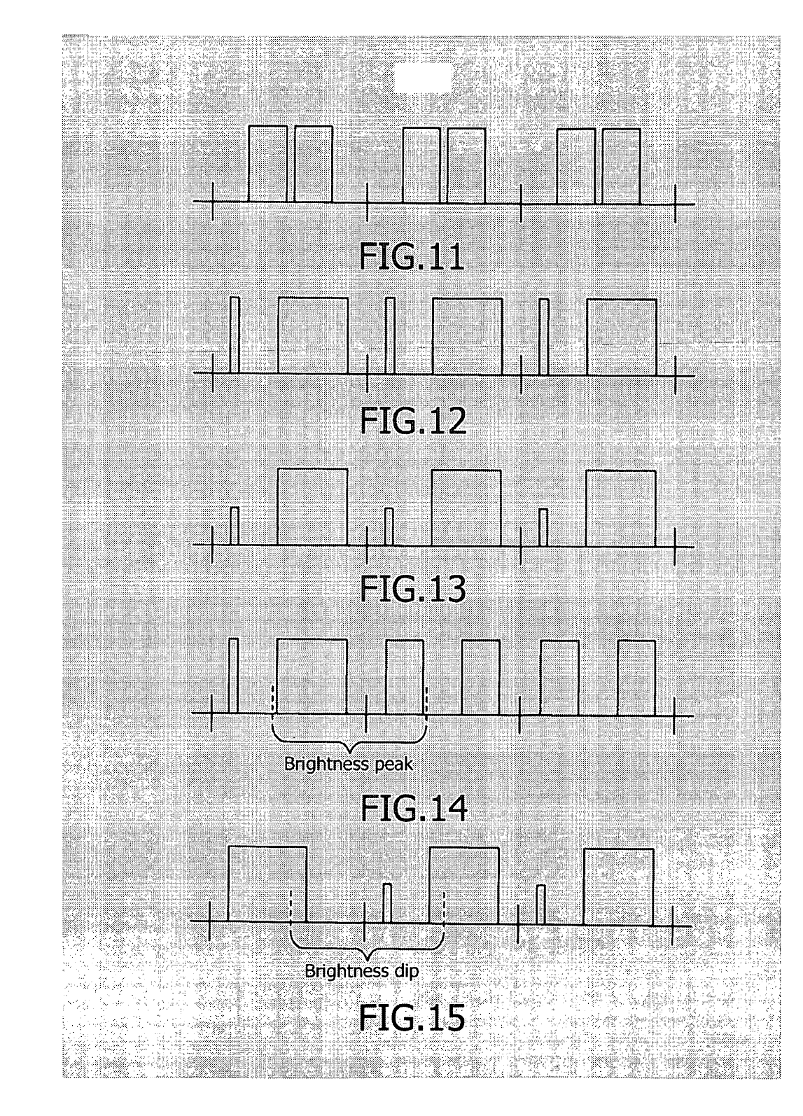

FIG. 5 is a flow chart illustrating a method for mode transition. In a first pattern signal generation step 500, a backlight control signal with a first pattern is generated. A signal with an intermediate pattern relatively similar to the first pattern is generated in an intermediate pattern signal generation step 502. In a determination step 504 it is determined if more intermediate patterns should be inserted. This can be dynamically determined or determined from a predefined transition procedure. If further patterns are to be inserted, the method returns to the intermediate pattern signal generation step 502. Otherwise, the method continues with a second pattern signal generation step 506 where the backlighting is operated in the second mode, and the transition is ready.

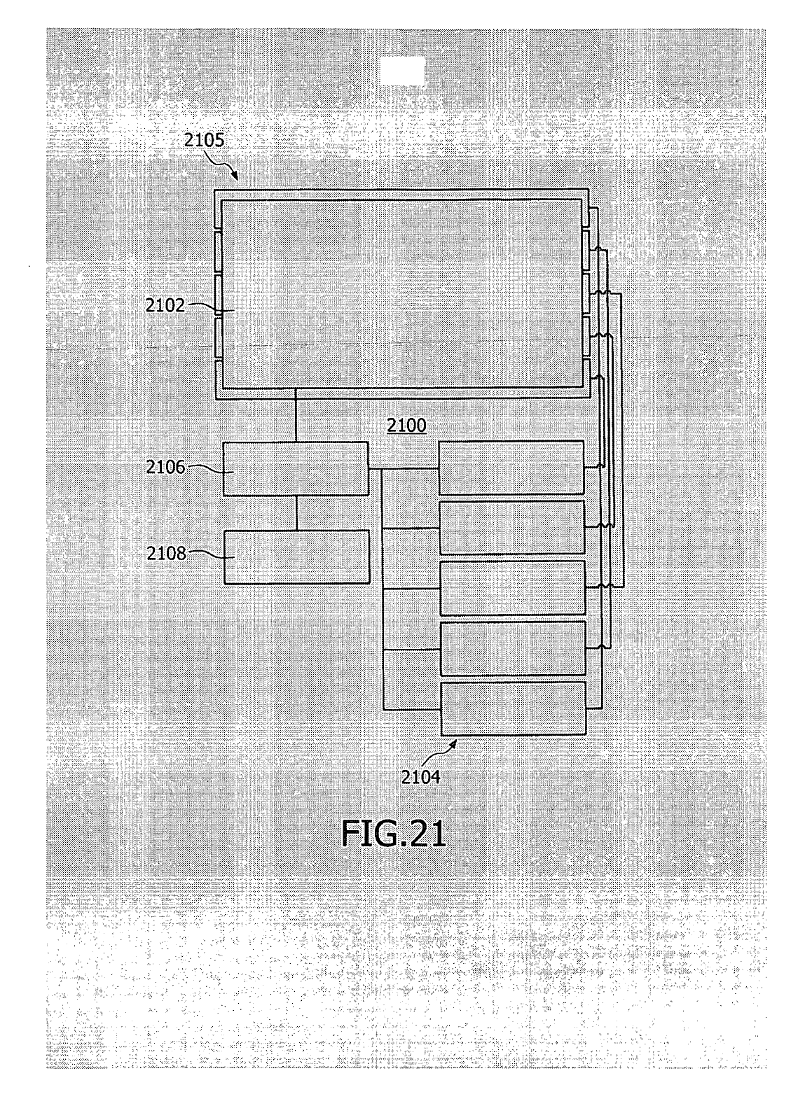

FIG. 21 illustrates a display 2100 comprising a display panel 2102. The display panel 2102, which can be a LCD (Liquid Crystal Display) panel, is provided with a plurality of backlighting units 2105. Each of the backlighting units 2105 can for example comprise one or more lighting units, such as light emitting diodes (LEDs) or gas discharge lamps. The backlight is flashed, either for the entire panel 2102 or, preferably, by scanning backlight units 2105. Thus, an LC cell is illuminated only for a certain fraction of the frame time. Backlight controllers 2104, which are connected to the backlighting units 2105 of the panel 2102, controls backlight flashing. To avoid large area flicker, the backlight controllers 2104 provide backlight control signals which are dependent on an image displayed on an associated part of the panel 2102. Therefore, the backlight controllers are connected to a display controller 2106, which in turn receives image data from an image data source 2108. It should be noted that this description is for illustrative purpose, and both the backlight controllers 2104 and the display controller 2106 can be a common video controller, or divided between two or more units, which provide the same function as the backlight and display controllers 2104, 2106. The data source 2108 can be a TV decoder, a DVD player, a computer, or any other means providing images to be viewed on the display 2100.

In some cases, image contents are segmented, e.g. a cloudy, bright sky at top and at bottom a dark ground, with sharp letters in subtitles. Therefore, in some cases, it is desirable to segment the driving of the backlight accordingly, i.e. by backlight units 2165 associated to the part of the image to be shown on the display 2100. The present invention is also applicable to this. Thus, the backlighting is not only improved for each type of image, the backlighting is also improved for each part of the image associated to backlight units 2105. To be able to implement this, there is a few things to consider.

Analysis of the image is performed for each part of the image, where the part can be defined by a part illuminated by a certain lighting unit, or a part comprising a certain type of image contents.

To avoid unwanted effects at borders between parts of the image, the transition between a pulse pattern in one part to another part is treated similar to the transition between a first and a second backlight pattern described above. If there is a moving object at a border between two parts of the image, the different effects of the different pulse patterns are reduced by crosstalk between the backlighting units associated with the pulse patterns.

It can be noted that driving the backlighting in double pulse modes, or multi pulse modes, will in some cases produce more light than with single pulse, although the same total pulse duration. An explanation to this is that a switch-off time for a backlight unit last longer than a switch-on time. This is the case for some types of backlight units, and the opposite effect can be observed for other types of backlight units. The difference in lighting can, as described above, be prevented by using quasi-single pulse patterns. As an alternative to quasi-single pulse patterns, single pulse patterns, which provides some additional time for reactive components to settle and thus a somewhat sharper image, can be used, but with a compensation factor added to the pulse to equalize to a quasi-single, double, or multi pulse pattern. It is preferable to have a look-up table, with compensation factors for different pulse patterns for the actual light source or sources, from which compensation factors are used to enable seamless transitions between different pulse patterns, especially when used in neighboring partitions of an image.

However, when a seamless transition is to be made between single and dual or multi pulse patterns, the following procedure can be used:

i) If the double or multi pulses are bigger than the shortest possible pulse, they remain on its stationary position;
ii) When the double or multi pulses are supposed to get shorter than the shortest specified pulse that the lighting unit can handle, the double or multi pulses gradually shift towards a main pulse of the pulse pattern, such that the auxiliary pulses of the pulse pattern are closest possible to the main pulse when they are supposed to disappear. The auxiliary pulses keep their minimum duration until they disappear. In this way, even before the auxiliary pulses get switched off, their contribution to blur due to a too early exposure of reactive components to the light gets smaller.
iii) If the conditions change such that single pulse mode is not necessary, the double or multi pulses go back to their stationary positions.
iv) Once the auxiliary pulses are next to the main pulse, they can be switched off, taking account of a compensation factor, as described above, for the light output difference. As for scene shifts, the change can be made instantaneously, i.e. only performing the step iv).

1. A method for displaying images on a display having backlight, said images being updated periodically with a period, the method comprising the steps of:
generating a signal with a pulse pattern for each period depending on contents of an image to be displayed in that period; and
activating the backlight in accordance with said signal.

2. The method according to claim 1, wherein said backlight comprises a plurality of lighting units and each lighting unit is associated with a part of said display, wherein said steps of generating a signal and activating backlight are separately adapted to each of said parts.

3. The method according to claim 1, wherein said pulse pattern comprises a plurality of pulses for each period when said contents of displayed images comprise relatively high brightness.

4. The method according to claim 3, wherein said plurality of pulses are symmetrical during said period when contents of displayed images comprise low changes between subsequent images.

5. The method according to claim 3, wherein said plurality of pulses are asymmetrical during said period when contents of displayed images comprise high changes between subsequent images.

6. The method according to claim 1, wherein said pulse pattern comprises one pulse for each period when said contents of displayed images comprise high changes between subsequent images and relatively low brightness.

7. The method according to claim 1, wherein contents change between subsequent images, further comprising the steps of:
generating said signal with a first pattern;
generating said signal with intermediate patterns; and
generating said signal with a second pattern,
wherein said intermediate patterns are such that an average value of said signal is kept constant upon a transition from said first pattern to said second pattern.

8. The method according to claim 7, wherein said first pattern is a single pulse for each period, said second pattern is two symmetrical pulses, and said intermediate patterns are two pulses with different effective pulse brightnesses.

9. The method according to claim 7, wherein said first pattern is two symmetrical pulses for each period, said second pattern is a single pulse for each period, and said intermediate patterns are two pulses with different effective pulse brightnesses.

10. The method according to claim 7, wherein an aggregated effective pulse brightness of said pulses within each period is constant.

11. A display (100) comprising a display panel (102) and a backlight unit, wherein said backlight unit comprises a controller (104) and a lighting device, wherein said controller (104) is arranged to generate a control signal, and said lighting device is arranged to provide backlight to said display panel (102) according to said control signal, wherein said control signal comprises a pulse pattern depending on contents of displayed images.

12. The display (100) according to claim 11, wherein said backlight unit comprises a plurality of lighting devices and each lighting device is associated with a part of said display, and said control signal is separately adapted to each of said parts.
